(19) United States
(12) Patent Application Publication
(10) Pub. No.: US 2009/0097503 A1
(43) Pub. Date: Apr. 16, 2009

(54) METHOD AND SYSTEM FOR TRANSMISSION OF DECODED MULTI-CHANNEL DIGITAL AUDIO IN SPDIF FORMAT

(76) Inventors: Richa Jain, Bangalore (IN); Brajabandhu Mishra, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/872,340

(22) Filed: Oct. 15, 2007

(51) Int. Cl. H04Q 11/00

(52) U.S. Cl. 370/474

(57) ABSTRACT

A method and system for processing multi-channel audio data may include selecting one or more SPDIF data frames from a plurality of decoded multi-channel audio data frames. The selected one or more SPDIF data frames, header information corresponding to the one or more SPDIF data frames, and/or one or more channel status bits corresponding to the one or more SPDIF data frames may be packetized. The one or more channel status bits may indicate one or more audio channels for the selected one or more SPDIF data frames. The indication of the one or more audio channels may be stored in at least one multi-channel mode field of the one or more channel status bits. The packetized one or more SPDIF data frames may be from a single audio channel and/or from a plurality of audio channels.

### CROSS-REFERENCE TO RELATED APPLICATIONS/INCORPORATION BY REFERENCE

This application makes reference to U.S. patent application Ser. No. ______ (Attorney Docket No. 18346US01), filed on Oct. 15, 2007, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to processing of audio data. More specifically, certain embodiments of the invention relate to a method and system for transmission of multi-channel digital audio in SPDIF format.

### BACKGROUND OF THE INVENTION

Digital data communications have increased in popularity in recent years and have found a wide variety of applications. One such application includes the transmission and reception of digital audio using the Sony/Philips Data Interface Format (SPDIF). The SPDIF protocol is further described in International Electrotechnical Commission publication 60958-3 Ed. 1.0 entitled “Digital audio interface—Part 3: Consumer applications.”

The SPDIF protocol defines a serial data stream organized in sub-frames, frames and blocks. Upon transmission, digital audio data is encoded and is transmitted via specialized SPDIF cable to one or more location for processing. Each of the receiving locations uses an SPDIF receiver/decoder that receives the encoded SPDIF data, decodes it and communicates it to one or more speakers. This conventional digital audio processing scenario is not efficient as the specialized SPDIF cable connecting the SPDIF transmitter to the SPDIF receiver, as well as the SPDIF decoder itself, are very expensive. Furthermore, expenses may increase exponentially if the encoded SPDIF audio data is transmitted to more than one location. In this regard, additional SPDIF cable is required to communicate the encoded data, and additional SPDIF receivers/decoders are required at each location. Additionally, at present, the SPDIF protocol handles transmission of decoded stereo data. The SPDIF protocol does not make any provisions for transmission of decoded multi-channel audio data.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A method and system for transmission of decoded multi-channel digital audio in SPDIF format, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating the format of an exemplary SPDIF data block, which may be used in accordance with an embodiment of the invention.

FIG. 1B is a block diagram illustrating formatting of stereo audio data in an exemplary SPDIF data frame, which may be used in accordance with an embodiment of the invention.

FIG. 1C is a block diagram illustrating formatting of multi-channel audio data in exemplary SPDIF data frames for a plurality of audio channels, which may be used in accordance with an embodiment of the invention.

FIG. 1D is a block diagram illustrating exemplary packetization of SPDIF data frames where each packet comprises multi-channel audio data from a plurality of audio channels, in accordance with an embodiment of the invention.

FIG. 1E is a block diagram illustrating exemplary packetization of SPDIF data frames where each packet comprises multi-channel audio data from a single audio channel, in accordance with an embodiment of the invention.

FIG. 2 is a block diagram of a conventional multi-channel SPDIF digital audio processing system.

FIG. 3 is a block diagram of a multi-channel SPDIF digital audio processing system for transmission of decoded SPDIF digital audio data to a plurality of receivers, in accordance with an embodiment of the invention.

FIG. 4 is a block diagram of an exemplary SPDIF data processing block for receiving decoded SPDIF audio data, in accordance with an embodiment of the invention.

FIG. 5 is a flow diagram illustrating exemplary steps for processing multi-channel SPDIF data packets comprising one or more channel status bits in the header, in accordance with an embodiment of the invention.

FIG. 6 is a flow diagram illustrating exemplary steps for processing multi-channel SPDIF data packets and channel status bits packets, in accordance with an embodiment of the invention.

### DETAILED DESCRIPTION OF THE INVENTION

Certain aspects of the invention may be found in a method and system for processing decoded multi-channel audio data, and may include selecting one or more SPDIF data frames from a plurality of multi-channel audio data frames. The selected one or more SPDIF data frames and/or one or more channel status bits corresponding to the one or more SPDIF data frames may be packetized. The one or more channel status bits may indicate one or more audio channels for the selected one or more SPDIF data frames. The indication of the one or more audio channels may be stored in at least one multi-channel mode field of the one or more channel status bits. The packetized one or more SPDIF data frames may be from a single audio channel and/or from a plurality of audio channels. The packetized one or more SPDIF data frames may comprise an SPDIF audio block from a single audio channel. The plurality of multi-channel audio data frames may comprise decoded SPDIF audio data frames. At least one SPDIF packet may be generated based on the packetizing of the selected one or more SPDIF data frames. At least one header may be generated for the at least one SPDIF packet, and the generated header for the at least one SPDIF packet may comprises the one or more channel status bits and/or a packet sequence number. The at least one SPDIF packet comprising the generated at least one header may be transmitted to at least one receiver for processing. The at least one SPDIF packet may be transmitted via the Internet, an Intranet, a wireless LAN, and/or a Bluetooth connection.

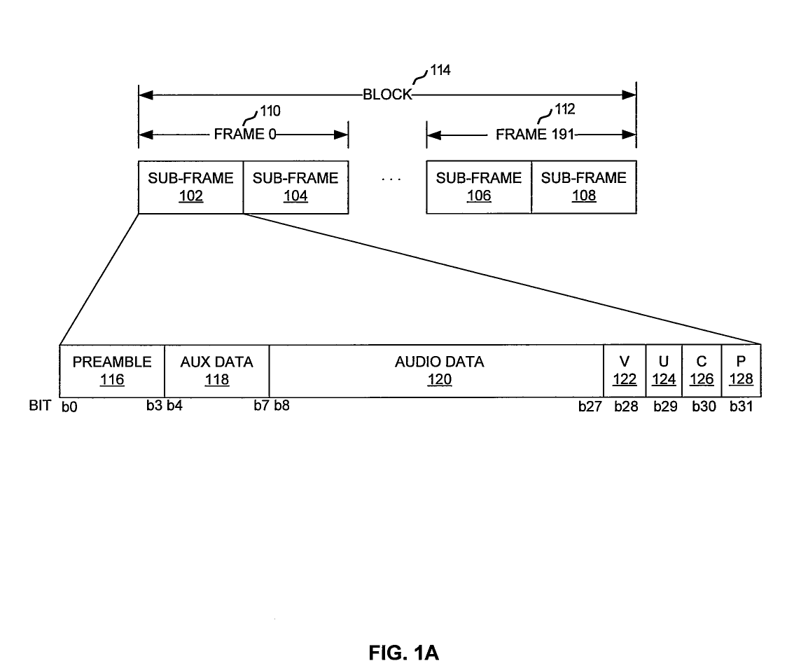

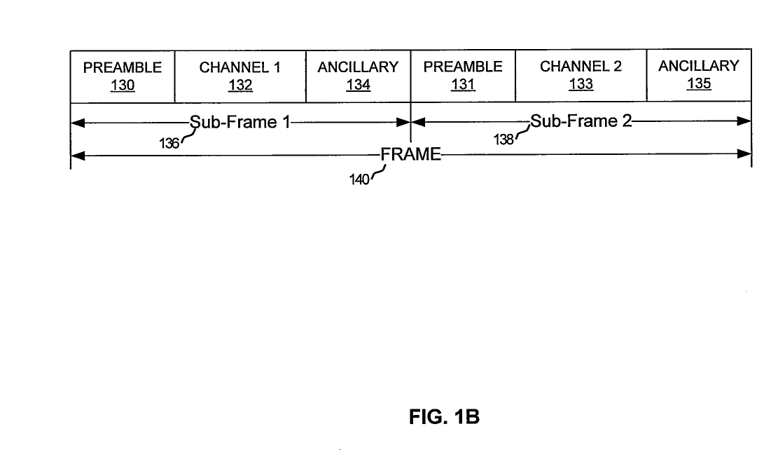

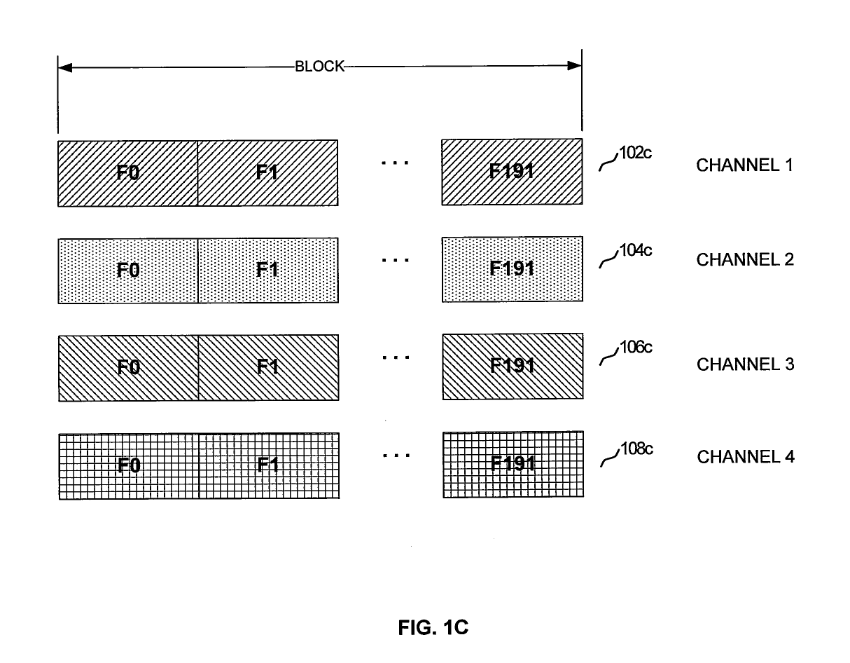

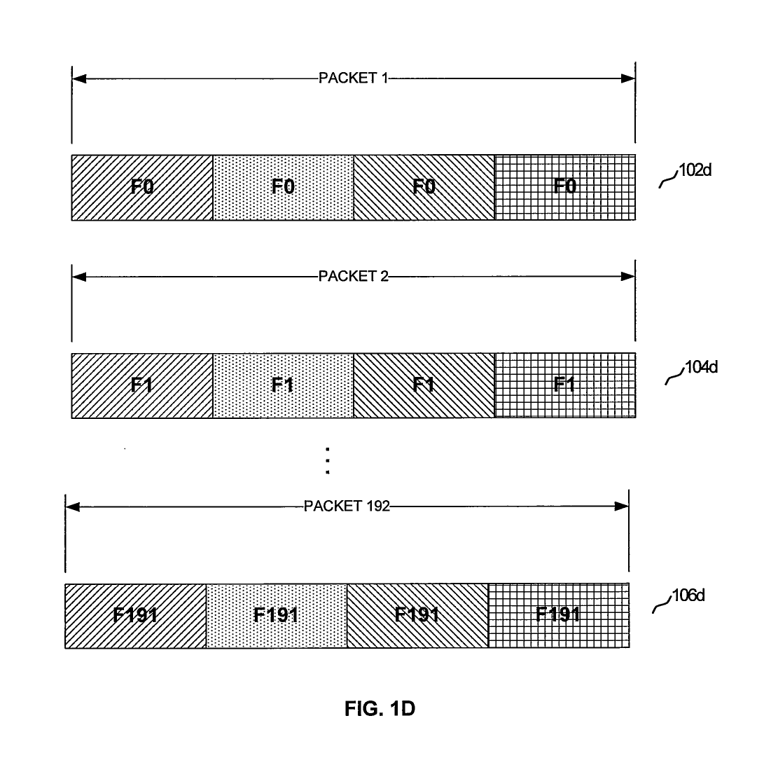

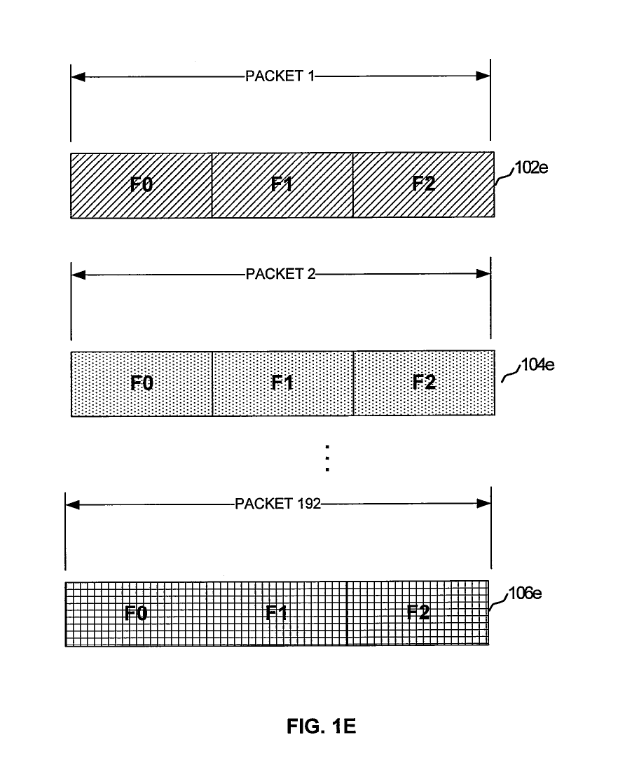

FIG. 1A is a block diagram illustrating the format of an exemplary SPDIF data block, which may be used in accordance with an embodiment of the invention. Referring to FIG. 1A, each SPDIF block 114 may comprise 192 frames, frame 0 (110) through frame 191 (112). Each of the SPDIF frames 110, . . . , 112 may comprise two sub-frames. For example, frame 110 may comprise sub-frames 102 and 104. Similarly, frame 112 may comprise sub-frames 106 and 108. Each of the SPDIF sub-frames may comprise 32 time slots or bits. For example, sub-frame 102 may comprise 32 bits, b0, . . . , b31. Each sub-frame, such as the sub-frame 102, may comprise a preamble 116, digital data 118, 120, and ancillary information 122, . . . , 128.

The preamble 116 may comprise 4 bits (b0, . . . , b3). Bits b4, . . . , b27 may be used to represent digital data. In some instances, the auxiliary data field 118 may be used to provide non-audio information, such as information which may be used to identify the type of audio data. For example, in one embodiment of the invention, the auxiliary data field 118 may be used to identify whether the audio data 120 is stereo audio data or multi-channel audio data. The ancillary information may comprise four additional bits 122, . . . , 128, designated as bits b28, . . . , b31. Bit 28 (122) may comprise a validity bit, which may be used to encode a data sample validity flag. Bit 29 (124) may comprise a user data bit 124, which may be used to encode user information. Bit 30 (126) may comprise a channel status bit, which may be used to encode channel status information. Bit 31 (128) may comprise a parity bit.

In an exemplary embodiment of the invention, one or more of bits b28, b31 from the ancillary information fields of the SPDIF sub-frames 102, . . . , 108 may be used for transmission of decoded SPDIF digital audio data to one or more receivers. For example, the channel status bit 126 from each of the 192 SPDIF frames 110, . . . , 112 may be extracted to obtain a total of 192 channel status bits (CSBs). The extracted CSBs may be transmitted with the decoded SPDIF digital audio data to one or more receivers via, for example, the Internet and/or an Intranet.

FIG. 1B is a block diagram illustrating formatting of stereo audio data in an exemplary SPDIF data frame, which may be used in accordance with an embodiment of the invention. Referring to FIG. 1B, the SPDIF frame 140 may comprise sub-frames 136 and 138. The data format of the SPDIF sub-frames 136 and 138 may be similar to the format of sub-frame 102 in FIG. 1A. For example, sub-frame 136 may comprise a preamble 130, audio data 132 and ancillary information 134. Similarly, sub-frame 138 may comprise a preamble 131, audio data 133 and ancillary information 135. The SPDIF data frame 140 may be used to communicate stereo audio data, such as linear pulse code modulated (LPCM) data, comprising two channels. In this regard, audio data portion 132 of the sub-frame 136 may be used to communicate channel 1 data and audio data portion 133 of the sub-frame 138 may be used to communicate channel 2 data.

In an exemplary embodiment of the invention, one or more of CSBs from the ancillary information fields 134 and 135 of the SPDIF sub-frames 136 and 138 may be used for transmission of decoded SPDIF digital stereo data to one or more receivers. The extracted CSBs may be transmitted with the decoded SPDIF digital stereo audio data to one or more receivers via, for example, the Internet and/or an Intranet.

FIG. 1C is a block diagram illustrating formatting of multi-channel audio data in exemplary SPDIF data frames for a plurality of audio channels, which may be used in accordance with an embodiment of the invention. Referring to FIG. 1C, there is illustrated a plurality of SPDIF data frames from a plurality of audio channels. For example, an audio data block from a first channel 102c may comprise 192 SPDIF data frames F0, . . . , F191. Similarly, an audio data block from a second channel 104c may comprise 192 SPDIF data frames F0, . . . , F191. An audio data block from a third channel 106c may comprise 192 SPDIF data frames F0, . . . , F191, and an audio data block from a fourth channel 108c may comprise 192 SPDIF data frames F0, . . . , F191.

Even though four-channel audio data frames are utilized in reference to at least FIGS. 1C-1E, the present invention may not be so limited. In this regard, other types of multi-channel audio data, such as 5.1-channel or 7.1-channel audio data and any future multichannel audio mode data, may also be utilized.

FIG. 1D is a block diagram illustrating exemplary packetization of SPDIF data frames where each packet comprises multi-channel audio data from a plurality of audio channels, in accordance with an embodiment of the invention. Referring to FIG. 1D, there is illustrated a plurality of packets 102d, . . . , 106d using multi-channel audio data from the plurality of channels 102c, . . . , 108c. In one embodiment of the invention, each packet may comprise corresponding frames from each of the audio channels 102c, . . . , 108c. For example, packet 102d may comprise frames F0 from each of the four audio channels 102c, . . . , 108c. Similarly, packet 104d may comprise frames F1 and packet 106d may comprise frames F191 from each of the four audio channels 102c, . . . , 108c.

FIG. 1E is a block diagram illustrating exemplary packetization of SPDIF data frames where each packet comprises multi-channel audio data from a single audio channel, in accordance with an embodiment of the invention. Referring to FIG. 1E, there is illustrated a plurality of packets 102e, . . . , 106e using multi-channel audio data from individual channels selected from the plurality of channels 102c, . . . , 108c. In one embodiment of the invention, each packet may comprise corresponding frames from a single channel. For example, packet 102e may comprise frames F0, . . . , F2 from the first channel 102c. Similarly, packet 104e may comprise frames F0, . . . , F2 from the second channel 104c, and packet 106e may comprise frames F0, . . . , F2 from the fourth channel 106c.

Referring to FIGS. 1C-1E, the multi-channel audio data from channels 102c, . . . , 108c may be packetized using a plurality of packetization techniques, such as the packetization techniques described above with regard to FIG. 1D (each packet comprises one or more frames from one or more audio channels) and FIG. 1E (each packet comprises frames from only a single audio channel). Another packetization technique which may be utilized (and is not illustrated in the figures) may be to packetize one entire block for a given audio channel. For example, channel status bits may be used to indicate one or more audio channels in corresponding packets that comprise multi-channel SPDIF data. In one embodiment of the invention, the channel status bits may be packetized in a header for the multi-channel SPDIF data packet. In another embodiment, the channel status bits may be packetized in a separate packet. Notwithstanding, the present invention may not be limited by the packetization technique utilized and other packetization techniques for packetizing decoded multi-channel audio data may also be utilized, such as the packetization and transmission techniques disclosed in U.S. patent application Ser. No. ______ (Attorney Docket No. 18346US01).

U.S. patent application Ser. No. ______ (Attorney Docket No. 18346US01), filed on even date herewith, discloses various ways of packetizing and transmitting decoded SPDIF audio data over the Internet, an Intranet, a wireless LAN and/or a Bluetooth connection, for example, and is incorporated herein by reference in its entirety.

In one embodiment of the invention, the SPDIF protocol may be modified so as to allow identification of the specific audio channel, or channels, for a transmitted packet of multi-channel SPDIF data. For example, the “multi-channel mode number” field in the channel status bits may be used to indicate multi-channel configuration for decoded multi-channel SPDIF data. In some instances, the “user defined multi-channel mode” field in the channels status bits may be used to indicate the audio channel for corresponding multi-channel SPDIF data. In other instances, the currently reserved states of the channel status bits may be used to indicate the audio channel for corresponding multi-channel SPDIF data.

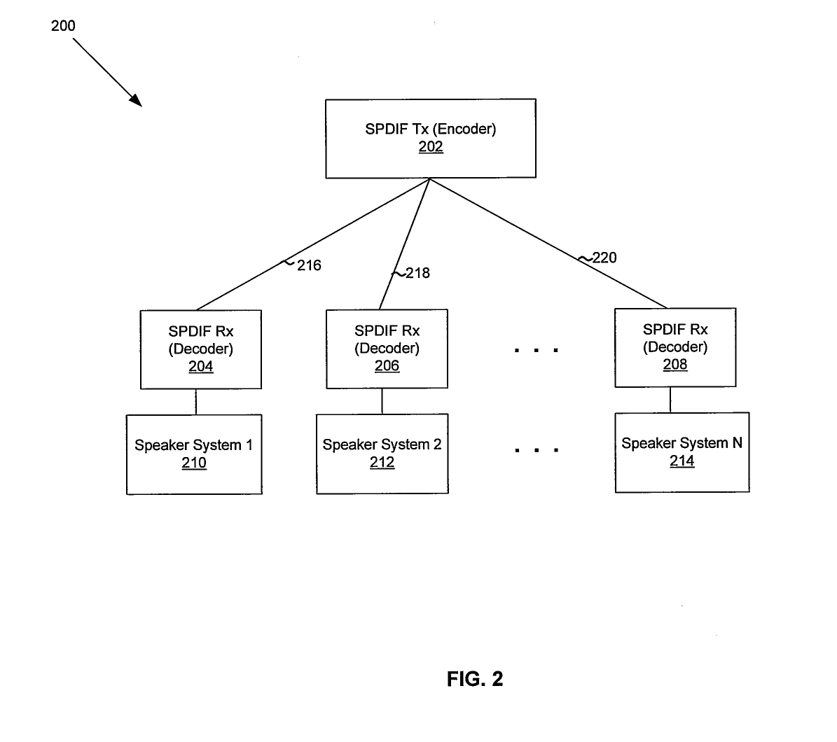

FIG. 2 is a block diagram of a conventional multi-channel SPDIF digital audio processing system. Referring to FIG. 2, the SPDIF digital audio processing system 200 may comprise a SPDIF transmitter (Tx) 202, SPDIF receivers (Rx) 204, . . . , 208, and corresponding speaker systems 210, . . . , 214.

The SPDIF Tx 202 may comprise suitable logic, circuitry, and/or code that may enable encoding and transmission of multi-channel SPDIF digital audio data. For example, the SPDIF Tx 202 may encode multi-channel SPDIF digital audio data and may transmit the encoded multi-channel SPDIF digital audio data to one or more receivers, such as the SPDIF Rx 204, . . . , 208. The encoded multi-channel SPDIF digital audio data may be transmitted to the SPDIF Rx 204, . . . , 208 via specialized SPDIF cables 216, . . . , 220, respectively.

The SPDIF Rx 204, . . . , 208 may comprise suitable logic, circuitry, and/or code that may enable receiving and decoding of the multi-channel SPDIF digital audio data transmitted by the SPDIF Tx 202. The SPDIF Rx 204, . . . , 208 may communicate the decoded multi-channel SPDIF digital audio data to corresponding speaker systems 210, . . . , 214. The speaker systems 210, . . . , 214 may comprise a plurality of speakers adapted for use with multi-channel audio. For example, the speaker systems 210, . . . , 214 may each comprise surround sound speakers adapted for use with multi-channel audio, such as 5.1 or 7.1 audio, for example.

In one embodiment of the invention, the implementation cost and the efficiency of the multi-channel SPDIF digital audio processing system 200 may be significantly improved by using only a single decoder to decode the received encoded multi-channel SPDIF digital audio data, instead of using an SPDIF decoder at each remote location as illustrated with regard to FIG. 2. In this regard, only a single SPDIF cable may be used to connect the SPDIF Tx to the SPDIF Rx/decoder. One or more CSBs may be extracted from the decoded multi-channel SPDIF digital audio data and may be communicated with packetized multi-channel SPDIF data to one or more receivers via the Internet and/or an Intranet. The extracted CSBs may be used, as described herein, to carry audio channel information related to the multi-channel SPDIF data.

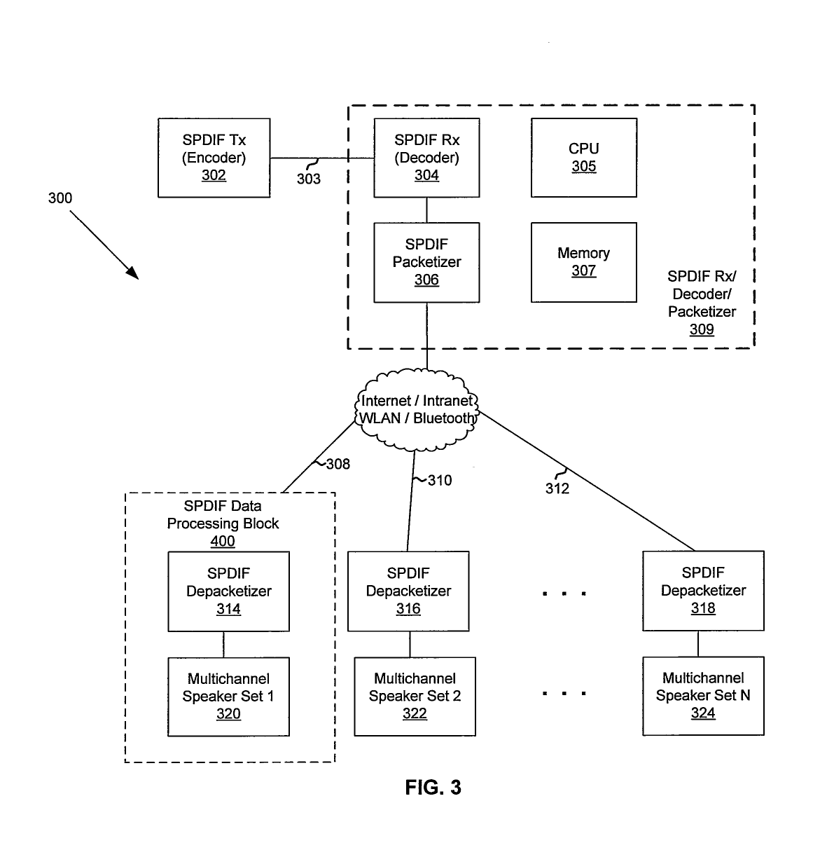

FIG. 3 is a block diagram of a multi-channel SPDIF digital audio processing system for transmission of decoded multi-channel SPDIF digital audio data to a plurality of receivers, in accordance with an embodiment of the invention. Referring to FIG. 3, the multi-channel SPDIF digital audio processing system 300 may comprise a SPDIF transmitter (Tx) 302, a SPDIF receiver (Rx)/decoder 304, and a SPDIF packetizer 306. The SPDIF digital audio processing system 300 may also comprise SPDIF depacketizers 314, . . . , 318 and corresponding SPDIF Rx (multichannel speaker sets) 320, . . . , 324.

The SPDIF Tx 302 may comprise suitable logic, circuitry, and/or code that may enable encoding and transmission of multi-channel SPDIF digital audio data. For example, the SPDIF Tx 202 may encode multi-channel SPDIF digital audio data and may transmit the encoded multi-channel SPDIF digital audio data to a single receiver/decoder, such as the SPDIF Rx 304. The encoded multi-channel SPDIF digital audio data may be transmitted to the SPDIF Rx 304 via a SPDIF cable 303.

The SPDIF Rx/decoder 304 may comprise suitable logic, circuitry, and/or code that may enable receiving and decoding of the SPDIF digital audio data transmitted by the SPDIF Tx 302 via the SPDIF cable 303. The SPDIF Rx/decoder 304 may communicate the decoded SPDIF digital audio data to the SPDIF packetizer 306. The SPDIF packetizer 306 may comprise suitable logic, circuitry, and/or code that may enable packetizing of SPDIF data into, for example, SPDIF data packets suitable for transmission over the Internet or an Intranet. The SPDIF packetizer 306 may also enable generating one or more headers for the SPDIF data packets, where the headers may comprise one or more extracted CSBs and/or a packet sequence number. In some instances, the SPDIF packetizer 306 may packetize the extracted CSBs into separate CSB packets, which may be transmitted together with the SPDIF data packets to the SPDIF depacketizers 314, . . . , 318. In another embodiment of the invention, the CSBs packets may be sent via Transmission Control Protocol (TCP), and the SPDIF data packets may be sent via User Datagram Protocol (UDP), for example.

The SPDIF depacketizers 314, . . . , 318 may comprise suitable logic, circuitry, and/or code that may enable depacketization of the received multi-channel SPDIF data packets and/or the CSBs packets and/or the headers. The depacketized multi-channel SPDIF digital audio information may then be communicated to the corresponding SPDIF Rx (multichannel speaker sets) 320, . . . , 322. The SPDIF Rx (audio players/speaker sets) 210, . . . , 214 may comprise a plurality of speakers adapted for use with multi-channel audio, such as surround sound speakers adapted for use with 5.1 or 7.1 audio, for example.

In operation, the SPDIF Tx 302 may encode multi-channel SPDIF digital audio data and may transmit the encoded multi-channel SPDIF digital audio data to the SPDIF Rx/decoder 304 via the SPDIF cable connection 303. The SPDIF Rx/decoder 304 may decode the received encoded multi-channel SPDIF digital audio data. The decoded multi-channel SPDIF digital audio data may be communicated to the SPDIF packetizer 306. The SPDIF packetizer 306 may collect each block of multi-channel SPDIF data, comprising 192 frames, and may extract the 192 channel status bits from each multi-channel SPDIF data block. The SPDIF packetizer 306 may then break up each of the SPDIF blocks into packets using one or more different techniques.

For example, in one embodiment of the invention, the following SPDIF data packetization technique may be used: each multi-channel SPDIF data block may be broken into n data packets. In this regard, each data packet may comprise 192/n SPDIF data frames, and the size of each SPDIF data packet will be (192*8/n). In yet another embodiment of the invention, the following SPDIF data packetization technique may be used: the SPDIF data packet size of X may be used, where X may be a multiple of 8. The SPDIF packetizer 306 may then fill each SPDIF data packet with size X with as many SPDIF frames as possible.

Even though only two packetization techniques used by the SPDIF packetizer 306 are disclosed, the present invention may not be so limited. In this regard, the SPDIF packetizer 306 may also utilize other techniques for packetization of SPDIF data and/or CSBs.

The multi-channel SPDIF data packets generated by the SPDIF packetizer 306 may be communicated to the SPDIF depacketizers 314, . . . , 318 with or without packet headers. In Instances when the multi-channel SPDIF data packets comprise a header, each packet header may be used to communicate additional information or information for error recovery, for example. Each header may comprise, for example, 192 CSBs extracted from each SPDIF block (each SPDIF block comprises 192 SPDIF frames, each frame contributing a single CSB). In addition, one or more of the CSBs may be used to carry audio channel information for the corresponding multi-channel SPDIF data within the packets. The SPDIF data packet header may also comprise a packet sequence number, which may designate the sequence number of the SPDIF packet in the block. The headers may be used at the SPDIF depacketizers 314, . . . , 318, for error recovery or for transmission of any additional information.

In another embodiment of the invention, the 192 CSBs extracted from each SPDIF block may be packetized and transmitted in a separate packet. In such instances when the CSBs are packetized separately, the SPDIF data packet header may comprise only the packet sequence number. The CSB packets and the SPDIF data packets may then be encapsulated and transmitted over the Internet or an Intranet to the SPDIF depacketizers 314, . . . , 318. The SPDIF packetizer 306 may encapsulate the SPDIF data packets and/or the CSBs packets and/or the headers as Ethernet packets, as transport layer protocol packets, such as TCP and/or UDP packets, as Wireless LAN (802.11) packets, and/or as Bluetooth packets.

After the SPDIF packetizer 306 generates the SPDIF data packets (with or without headers) and/or the CSBs packets, the SPDIF data packets (with or without headers) and/or the CSBs packets may be transmitted via the Internet/Intranet/WLAN, or Bluetooth and the connections 308, . . . , 312 to the SPDIF depacketizers 314, . . . , 318. The SPDIF depacketizers 314, . . . , 318 may depacketize the received SPDIF data packets and/or CSBs packets and communicate the depacketized and decided SPDIF digital audio data to the corresponding multichannel speaker sets 320, . . . , 324.

Even though the SPDIF Rx/decoder 304 and the SPDIF packetizer 306 are shown in FIG. 3 as separate blocks, the present invention may not be so limited. In one embodiment of the invention, the SPDIF Rx/decoder 304 and the SPDIF packetizer 306 may be implemented within a single SPDIF Rx/decoder/packetizer (SPDIF RDP) block 309. In such instances, the SPDIF RDP 309 may also comprise a CPU 305 and memory 307. Furthermore, the CPU may perform one or more of the functionalities of the SPDIF Rx/decoder 304 and/or the SPDIF packetizer 306, as described above with regard to FIG. 3. Similarly, the SPDIF depacketizers 314, . . . , 318 and the SPDIF Rx (multichannel speaker sets) 320, . . . , 322, may be implemented within single blocks, such as the SPDIF data processing block (SPDIF DPB) 400 for example.

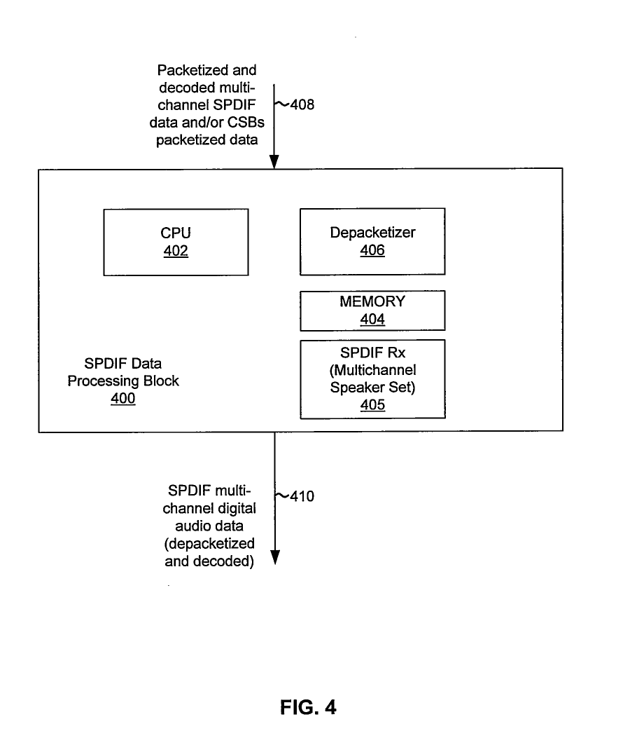

FIG. 4 is a block diagram of an exemplary SPDIF data processing block for receiving decoded SPDIF audio data, in accordance with an embodiment of the invention. Referring to FIG. 4, the SPDIF DPB 400 may comprise a CPU 402, a depacketizer 406, an SPDIF Rx (multichannel speaker set) 405, and memory 404. The depacketizer 406 may comprise suitable logic, circuitry, and/or code that may enable depacketization of packetized SPDIF data and/or CSBs packetized data. The SPDIF depacketizer may have the same functionalities as the functionalities of the SPDIF depacketizers 314, . . . , 318. The SPDIF Rx (multichannel speaker set) 405 may comprise suitable logic, circuitry, and/or code that may enable communication of decoded and depacketized SPDIF digital audio data to an audio player and/or speakers.

Referring to FIGS. 3 and 4, multi-channel SPDIF data packets (with or without headers), as well as CSBs packets, may be communicated to the SPDIF depacketizer 400 via the Internet/Intranet/WLAN/Bluetooth and one of the connections 308, . . . , 312. The SPDIF Rx/depacketizer may extract multi-channel SPDIF data from the received SPDIF data packets. In instances when the multi-channel SPDIF data packets comprise a header with CSBs, the SPDIF DPB 400 may also extract the CSBs from the header. In instances when the CSBs were communicated via a separate CSBs packet, the SPDIF Rx/depacketizer 400 may extract the 192 CSBs from the CSBs packet. In addition, the SPDIF Rx/depacketizer 400 may also extract audio channel information related to the multi-channel SPDIF data within the packets. The SPDIF Rx/depacketizer 400 may use the CSBs to acquire audio channel information, sample rate information, SPDIF data type information and/or copyright assertion information related to the received SPDIF data frames. The SPDIF Rx/depacketizer 400 may separate out the multichannel audio data and then feed the separated multichannel audio data to the multichannel speaker set 405.

In instances when a multi-channel SPDIF data packet has been lost in transmission, the SPDIF DPB 400 may use the frame sequence number from the header and the CSB information to formulate and insert the correct channel status bit information for the frames contained in the missing packet. The SPDIF DPB 400 may also extract critical information from the CSBs, such as sample rate information, SPDIF data type information and/or copyright assertion information. The depacketizer 406 may communicate the critical information to, for example, the SPDIF Rx (multichannel speaker set) 405 and to one or more of audio players/speakers. The SPDIF Rx (multichannel speaker set) 405 may use the extracted critical information to maintain its clock functioning without interruption, in instances when one or more SPDIF data packets are lost in transmission. In this regard, even if some of the frames containing crucial channel status information are lost, the SPDIF Rx (multichannel speaker set) 405 may recover and play SPDIF frames from the decoded and depacketized SPDIF data block. If the SPDIF Rx (multichannel speaker set) 405 is not able to recover the lost frames, it may construct them from the previous frames by, for example, applying suitable methods.

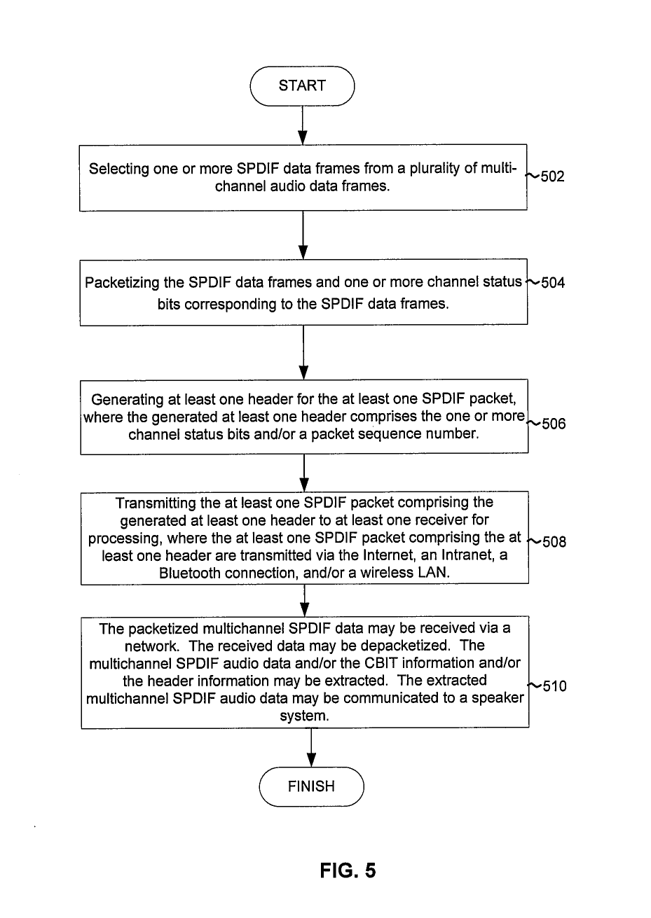

FIG. 5 is a flow diagram illustrating exemplary steps for processing multi-channel SPDIF data packets comprising one or more channel status bits in the header, in accordance with an embodiment of the invention. Referring to FIGS. 3, 4, and 5, at 502, the SPDIF packetizer 306 may select one or more SPDIF data frames from a plurality of decoded multi-channel audio data frames. The SPDIF data frames may be received from the SPDIF decoder 304. At 504, the SPDIF packetizer 306 may packetize the selected one or more SPDIF data frames and one or more channel status bits corresponding to the one or more SPDIF data frames. The one or more channel status bits may indicate one or more audio channels for the selected one or more SPDIF data frames. At 506, the SPDIF packetizer 306 may generate at least one header for the at least one SPDIF packet. The generated at least one header for the at least one SPDIF packet may comprise one or more extracted channel status bits and a packet sequence number. One or more of the channel status bits may be used to carry audio channel information. At 508, the SPDIF packetizer 306 may transmit the at least one SPDIF packet comprising the generated at least one header and/or channel status bit (CBIT) information to at least one receiver, such as the SPDIF DPB 400, for processing. The at least one SPDIF packet comprising the generated at least one header may be transmitted via the Internet, an Intranet, a Bluetooth connection, and a wireless LAN.

At 510, the packetized multichannel SPDIF data may be received by the SPDIF DPB 400 via a network. The received data may be depacketized by the SPDIF depacketizer 314. In this regard, the multichannel SPDIF audio data and/or the CBIT information and/or the header information may then be extracted. The extracted multichannel SPDIF audio data may be communicated to a speaker system, such as the multichannel speaker set 320.

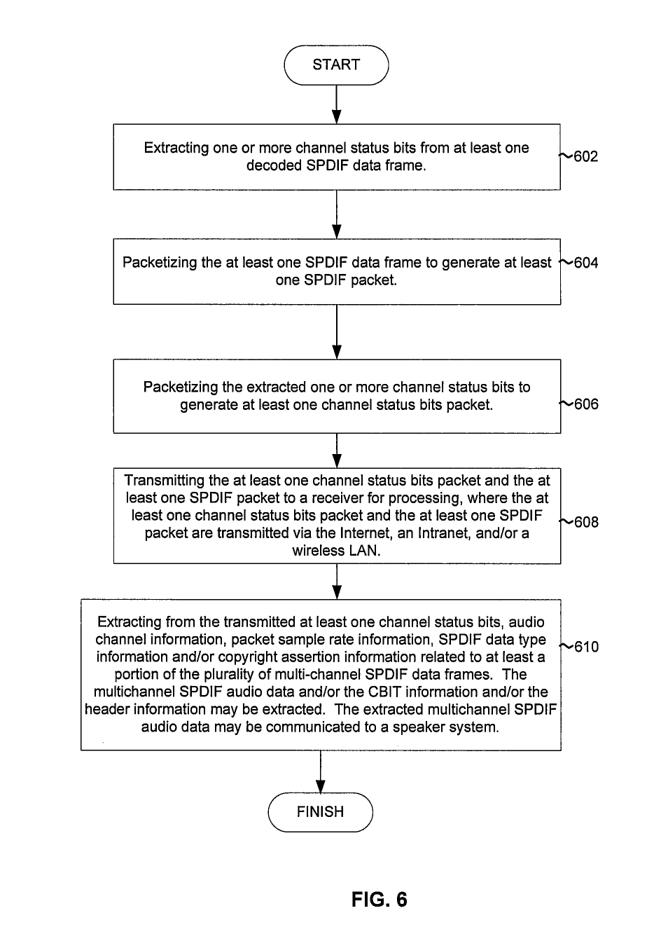

FIG. 6 is a flow diagram illustrating exemplary steps for processing multi-channel SPDIF data packets and channel status bits packets, in accordance with an embodiment of the invention. Referring to FIGS. 3, 4, and 6, at 602, the SPDIF packetizer 306 may extract one or more channel status bits from at least one decoded SPDIF data frame. The at least one decoded multichannel SPDIF data frame may be received from the SPDIF decoder 304. At 604, the SPDIF packetizer 306 may packetize the at least one SPDIF data frame to generate at least one SPDIF packet. At 606, the SPDIF packetizer 306 may packetize the extracted one or more channel status bits to generate at least one channel status bits (CSBs) packet. One or more of the extracted CSBs may be used to indicate audio channel information for corresponding multi-channel SPDIF data packet or packets. At 608, the SPDIF packetizer 306 may transmit the at least one channel status bits packet and the at least one SPDIF packet to at least one receiver for processing. The at least one channel status bits packet and the at least one SPDIF packet may be transmitted via the Internet, an Intranet, a Bluetooth connection and/or a wireless LAN.

At 610, the SPDIF depacketizer 314 may extract from the transmitted at least one channel status bits packet audio channel information, sample rate information, SPDIF data type information and/or copyright assertion information related to at least a portion of the plurality of SPDIF data frames. Furthermore, the SPDIF depacketizer 314 may also extract the multichannel SPDIF audio data and/or the CBIT information and/or the header information. The extracted multichannel SPDIF audio data may be communicated to a speaker system, such as the multichannel speaker set 320.

Certain embodiments of the invention may comprise a machine-readable storage having stored thereon, a computer program having at least one code section for processing multi-channel audio data, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing multi-channel audio data, the method comprising:
selecting one or more SPDIF data frames from a plurality of decoded multi-channel audio data frames; and
packetizing one or more of the following: said selected one or more SPDIF data frames, one or more channel status bits, and/or header information corresponding to said one or more SPDIF data frames, wherein said one or more channel status bits indicate one or more audio channels for said selected one or more SPDIF data frames.

2. The method according to claim 1, wherein said indication of said one or more audio channels is stored in at least one multi-channel mode field of said one or more channel status bits.

3. The method according to claim 1, wherein said packetized one or more SPDIF data frames are from a single audio channel.

4. The method according to claim 1, wherein said packetized one or more SPDIF data frames are from a plurality of audio channels.

5. The method according to claim 1, wherein said packetized one or more SPDIF data frames comprise an SPDIF audio block from a single audio channel.

6. The method according to claim 1, wherein said plurality of multi-channel audio data frames comprise decoded SPDIF audio data frames.

7. The method according to claim 1, comprising generating at least one SPDIF packet based on said packetizing of said selected one or more SPDIF data frames.

8. The method according to claim 7, comprising generating at least one header for said at least one SPDIF packet.

9. The method according to claim 8, wherein said generated at least one header for said at least one SPDIF packet comprises one or both of said one or more channel status bits and a packet sequence number.

10. The method according to claim 9, comprising transmitting one or both of the following: said at least one SPDIF packet comprising said generated at least one header and/or at least one CSB packet comprising said one or more channel status bits to at least one receiver for processing, wherein said at least one SPDIF packet comprising said generated at least one header is transmitted via one or more of the Internet, an Intranet, a wireless LAN, and/or a Bluetooth connection.

11. The method according to claim 10, comprising receiving at said at least one receiver, said transmitted one or both of the following: said at least one SPDIF packet comprising said generated at least one header and/or said at least one CSB packet comprising said one or more channel status bits.

12. The method according to claim 11, comprising extracting one or both of the following: said selected one or more SPDIF data frames and/or said one or more channel status bits.

13. The method according to claim 12, comprising communicating said extracted one or more SPDIF data frames to at least one multichannel speaker set.

14. The method according to claim 1, comprising packetizing said one or more channel status bits in at least one channel status bits (CSB) packet.

15. A system for processing multi-channel audio data, the system comprising:
at least one processor that selects one or more SPDIF data frames from a plurality of decoded multi-channel audio data frames; and
said at least one processor packetizes one or more of the following: said selected one or more SPDIF data frames, one or more channel status bits, and/or header information corresponding to said one or more SPDIF data frames, wherein said one or more channel status bits indicate one or more audio channels for said selected one or more SPDIF data frames.

16. The system according to claim 15, wherein said indication of said one or more audio channels is stored in at least one multi-channel mode field of said one or more channel status bits.

17. The system according to claim 15, wherein said packetized one or more SPDIF data frames are from a single audio channel.

18. The system according to claim 15, wherein said packetized one or more SPDIF data frames are from a plurality of audio channels.

19. The system according to claim 15, wherein said packetized one or more SPDIF data frames comprise an SPDIF audio block from a single audio channel.

20. The system according to claim 15, wherein said plurality of multi-channel audio data frames comprise decoded SPDIF audio data frames.

21. The system according to claim 15, wherein said at least one processor generates at least one SPDIF packet based on said packetizing of said selected one or more SPDIF data frames.

22. The system according to claim 21, wherein said at least one processor generates at least one header for said at least one SPDIF packet.

23. The system according to claim 22, wherein said generated at least one header for said at least one SPDIF packet comprises one or both of said one or more channel status bits and a packet sequence number.

24. The system according to claim 23, wherein said at least one processor transmits one or both of the following: said at least one SPDIF packet comprising said generated at least one header and/or at least one CSB packet comprising said one or more channel status bits to at least one receiver for processing, wherein said at least one SPDIF packet comprising said generated at least one header is transmitted via one or more of the Internet, an Intranet, a wireless LAN, and/or a Bluetooth connection.

25. The system according to claim 24, wherein said at least one processor receives at said at least one receiver, said transmitted one or both of the following: said at least one SPDIF packet comprising said generated at least one header and/or said at least one CSB packet comprising said one or more channel status bits.

26. The system according to claim 25, wherein said at least one processor extracts one or both of the following: said selected one or more SPDIF data frames and/or said one or more channel status bits.

27. The system according to claim 26, wherein said at least one processor communicates said extracted one or more SPDIF data frames to at least one multichannel speaker set.

28. The system according to claim 15, wherein said at least one processor packetizes said one or more channel status bits in at least one channel status bits (CSB) packet.
